(19) United States
(12) Patent Application Publication
(10) Pub. No.: US 2016/0280609 A1
(43) Pub. Date: Sep. 29, 2016

(54) SELF-PROPAGATING BRAZE

(71) Applicant: Rolls-Royce Corporation, Indianapolis, IN (US)

(72) Inventor: Andrew James Ritchey, Lafayette, IN (US)

(21) Appl. No.: 15/045,156

(22) Filed: Feb. 16, 2016

Related U.S. Application Data
(60) Provisional application No. 62/136,882, filed on Mar. 23, 2015.

(51) Int. Cl. C04B 37/00; B32B 3/06; B32B 18/00; B23K 35/36; B32B 7/12

(52) U.S. Cl. CPC C04B 37/005; B23K 35/3601; B32B 7/12; B32B 18/00; B32B 3/06; B32B 2255/20; C04B 2237/083; C04B 2237/60; C04B 2237/525

(57) ABSTRACT

A method may include positioning a first ceramic or ceramic matrix composite (CMC)part and a second ceramic or CMC part adjacent to each other to define a joint between adjacent portions of the first ceramic or CMC part and the second ceramic or CMC part. The method also may include introducing a carbon-containing filler at the joint; introducing molten silicon-containing braze material at the joint; and allowing silicon metal from the molten silicon-containing braze material to react with the carbon-containing filler to form silicon carbide and join the first ceramic or CMC part and the second ceramic or CMC part at the joint. In some examples, no external heat source directly heats the joint during the reaction of the molten silicon-containing braze material with the carbon-containing filler.

This application claims the benefit of U.S. Provisional Application number 62/136,882 filed Mar. 23, 2015, which is incorporated herein by reference in its entirety.

### TECHNICAL FIELD

The present disclosure generally relates to brazes for joining ceramic or ceramic matrix composite components.

### BACKGROUND

Some articles formed from ceramics or ceramic matrix composites (CMCs) are more easily formed out of multiple parts. For example the geometry of the article may be complex and may be difficult to form in a single piece. However, joining multiple parts formed of a ceramic or a CMC may be difficult, as the melting point of the ceramic or CMC may be very high, or the ceramic or CMC may decompose before melting.

### SUMMARY

In some examples, the disclosure describes a method that includes positioning a first ceramic or ceramic matrix composite (CMC) part and a second ceramic or CMC part adjacent to each other to define a joint between adjacent portions of the first ceramic or CMC part and the second ceramic or CMC part. The method also may include introducing a carbon-containing filler at the joint; introducing molten silicon-containing braze material at the joint; and allowing silicon metal from the molten silicon-containing braze material to react with the carbon-containing filler to form silicon carbide and join the first ceramic or CMC part and the second ceramic or CMC part at the joint. In some examples, no external heat source directly heats the joint during the reaction of the molten silicon-containing braze material with the carbon-containing filler.

In some examples, the disclosure describes an assembly including a first ceramic or ceramic matrix composite (CMC) part and a second ceramic or CMC part adjacent to the first ceramic or CMC part. The first and second ceramic or CMC parts may define a joint between adjacent portions of the first ceramic or CMC part and the second ceramic or CMC part. The assembly also may include a silicon injection port comprising an exit aperture positioned adjacent to the joint and a silicon injection port heat source positioned to heat at least one of the silicon injection port or a silicon-containing braze material disposed in the silicon injection port. Further, the assembly may include a carbon-containing filler at the joint. Molten silicon-containing braze material may be introduced to the joint through the silicon injection port, and silicon metal from the molten silicon-containing braze material may react with carbon from the carbon-containing filler to form silicon carbide and join the first ceramic or CMC part and the second ceramic or CMC part at the joint. In some examples, no external heat source directly heats the joint during the reaction of silicon metal from the molten silicon-containing braze material with carbon from the carbon-containing filler.

In some examples, the disclosure describes a system including a silicon injection port comprising an exit aperture positioned adjacent to a joint and a silicon injection port heat source positioned to heat at least one of the silicon injection port or a silicon-containing braze material disposed in the silicon injection port to result in the silicon-containing braze material being a molten silicon-containing braze material. The joint may be defined between respective surfaces of a first ceramic or ceramic matrix composite (CMC) part and a second ceramic or CMC part. The system also may include at least one heat source configured and positioned to preheat at least one of the first ceramic or CMC part or the second ceramic or CMC part to a temperature between about 900° C. and about 1,000° C. prior to the molten silicon-containing braze material being introduced to the joint. A carbon-containing filler may be positioned at the joint, and molten silicon-containing braze material may be introduced to the joint through the silicon injection port. Silicon metal from the molten silicon-containing braze material may react with carbon from the carbon-containing filler to form silicon carbide and join the first ceramic or CMC part and the second ceramic or CMC part at the joint. In some examples, no external heat source directly heats the joint during the reaction of the molten silicon-containing braze material with the carbon-containing filler.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a conceptual and schematic diagram illustrating an example assembly for joining a first ceramic or ceramic matrix composite (CMC) part and a second ceramic or CMC part using a silicon-containing braze material and a carbon-containing filler.

FIGS. 2A and 2B are conceptual and schematic diagrams illustrating an example joint between a first ceramic or CMC part and a second ceramic or CMC.

FIG. 3 is a flow diagram illustrating an example technique for joining a first ceramic or CMC part and a second ceramic or CMC part using a silicon-containing braze material and a carbon-containing filler.

FIG. 4 is a conceptual and schematic diagram illustrating another example assembly for joining a first ceramic or ceramic matrix composite (CMC) part and a second ceramic or CMC part using a silicon-containing braze material and a carbon-containing filler.

### DETAILED DESCRIPTION

The disclosure describes assemblies, systems, and techniques for forming a joint between a first ceramic or ceramic matrix composite (CMC) part and a second ceramic or CMC part using brazing with a braze alloy and a carbon-containing filler. As described above, joining multiple parts formed of a ceramic or a CMC may be difficult, as the melting point of the ceramic or CMC may be very high, or the ceramic or CMC may decompose before melting. Other brazing techniques may utilize a paste or a putty braze material, and may utilize excess braze material. The excess braze material may flow out of the joint unless a chemical or mechanical stop is used to contain the braze material. This may complicate assembly and increase time used to form a component.

By disposing a carbon-containing filler at the joint prior to introducing molten silicon-containing braze material, then introducing molten silicon-containing braze material to the joint, carbon from the carbon-containing filler may react with silicon metal from the molten silicon-containing braze material to form silicon carbide. The reaction of silicon metal and carbon is exothermic. Thus, the reaction of silicon metal and carbon may provide heat to help maintain the molten silicon-containing braze material in the molten state, such that the molten silicon-containing braze material can propagate throughout the joint. Carbon from the carbon-containing filler and silicon metal from the molten silicon-containing braze material may continue to react throughout the joint, forming silicon carbide. The silicon carbide may form as a solid, joining the first ceramic or CMC part and the second ceramic or CMC part.

In some examples, the carbon-containing filler may include a reinforcement phase, such that the joint is a CMC including the reinforcement phase and a silicon carbide matrix after formation of the silicon carbide by reaction of the carbon and the silicon metal. In this way, the joint between the first ceramic or ceramic CMC part and a second ceramic or CMC part may have improved mechanical properties compared to a joint including only silicon carbide matrix phase.

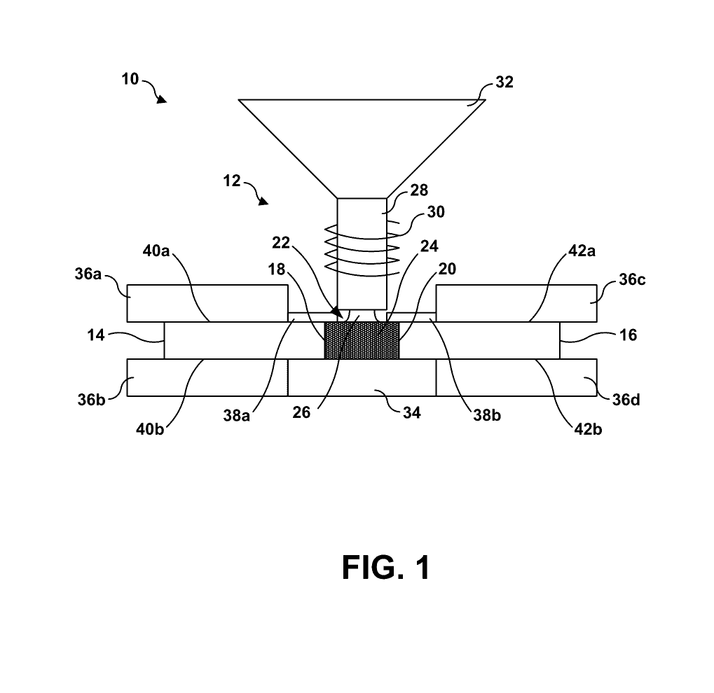

FIG. 1 is a conceptual and schematic diagram illustrating an example assembly 10 for joining a first ceramic or CMC part 14 and a second ceramic or CMC part 16 using a silicon-containing braze material 26 and a carbon-containing filler 24. Assembly 10 includes a system 12 including a silicon injection port 28, a silicon injection port heat source 30, and, optionally, at least one heat source 36a-36d (collectively, “at least one heat source 36”) configured and positioned to preheat at least one of the first ceramic or CMC part 14 or the second ceramic or CMC part 16. Assembly 10 also includes first ceramic or CMC part 14, second ceramic or CIVIC part 16, and carbon-containing filler 24.

First ceramic or CMC part 14 and second ceramic or CMC part 16 may be parts that form a component of a high temperature mechanical system. For example, first ceramic or CMC part 14 and second ceramic or CIVIC part 16 may together be a blade track, an airfoil, a blade, a combustion chamber liner, or the like, or a gas turbine engine. in some examples, first ceramic or CMC part 14 and second ceramic or CMC part 16 include a ceramic or a CIVIC that includes Si. In some examples, first ceramic or CIVIC part 14 and second ceramic or CMC part 16 may include a silicon-based material, such as silicon-based ceramic or a silicon-based CMC.

In some examples in which first ceramic or CMC part 14 and second ceramic or CMC part 16 include a ceramic, the ceramic may be substantially homogeneous. In some examples, first ceramic or CMC part 14 and second ceramic or CMC part 16 that includes a ceramic includes, for example, silicon carbide (SiC), transition metal carbides (e.g., WC, Mo₂C, TiC), transition metal suicides (MoSi₂NbSi₂, TiSi₂), or the like.

In examples in which first ceramic or CMC part 14 and second ceramic or CMC part 16 include a CMC, first ceramic or CMC part 14 and second ceramic or CMC part 16 include a matrix material and a reinforcement material. The matrix material includes a ceramic material, such as, for example, silicon metal or SiC. The CMC further includes a continuous or discontinuous reinforcement material. For example, the reinforcement material may include discontinuous whiskers, platelets, fibers, or particulates. As other examples, the reinforcement material may include a continuous monofilament or multifilament weave. In some examples, the reinforcement material may include SiC, C, or the like. In some examples, first ceramic or CMC part 14 and second ceramic or CMC part 16 include a SiC—SiC ceramic matrix composite. In some examples, first ceramic or CMC part 14 and second ceramic or CMC part 16 may be formed of the same material (ceramic or CMC). In other examples, first ceramic or CMC part 14 may be formed of a different material than second ceramic or CMC part 16.

Although FIG. 1 illustrates first ceramic or CMC part 14 and second ceramic or CMC part 16 as each defining a simple, substantially rectangular geometry, in other examples, first ceramic or CMC part 14, second ceramic or CMC part 16, or both may define a more complex geometry, including simple or complex curves, overhangs, undercuts, or the like.

First ceramic or CMC part 14 defines at least one joint surface 18. Similarly, second ceramic or CMC part 16 defines at least one joint surface 20. In some examples, joint surfaces 18 and 20 may define complementary shapes. FIG. 1 illustrates joint surfaces 18 and 20 as substantially flat surfaces. In other examples, joint surfaces 18 and 20 may define other, more complex shapes, including, for example, simple or complex curves, overhangs, undercuts, or the like.

First ceramic or CMC part 14 and second ceramic or CIVIC part 16 are positioned such that joint surfaces 18 and 20 are adjacent to each other and define a joint or joint location 22. Joint or joint location 22 may be any kind of joint, including, for example, at least one of a bridle joint, a butt joint, a miter join, a dado joint, a groove joint, a tongue and groove joint, a mortise and tenon joint, a birdsmouth joint, a halved joint, a biscuit joint, a lap joint, a double lap joint, a dovetail joint, or a splice joint. Consequently, joint surfaces 18 and 20 may have any corresponding geometries to define the surfaces of the joint 22. For example, for a mortise and tenon joint, first ceramic or CMC part 14 may define a mortise (a cavity) and second ceramic or CMC part 16 may define a tenon (a projection that inserts into the mortise). As another example, for a splice joint, first ceramic or CMC part 14 may define a half lap, a bevel lap, or the like, and second ceramic or CMC part 16 may define a complementary half lap bevel lap, or the like.

Disposed in joint or joint location 22 is a carbon-containing filler 24. Carbon-containing filler 24 may include carbon source. For example, carbon-containing filler 24 may include carbon source including a carbon yielding organic binder system (e.g., furan-derived binders), a powder containing graphite flakes, a powder containing carbon particles, or carbon fiber. In some examples, particles in the powder may include a smallest dimension that is less than about 100 micrometers, which may facilitate reaction of the silicon metal with the carbon. In other examples, particles the powder may include a smallest dimension larger than about 100 micrometers. In some examples, the carbon fiber may include short (e.g., chopped having a length on the order of 1 mm) carbon fiber. In some examples, the carbon fiber may include a unidirectional carbon fiber filler. The binder system, graphite flakes, carbon black, carbon fiber, diamond, or the like may react with the silicon (e.g., silicon metal) to form silicon carbide.

The carbon source may react with silicon metal in molten silicon-containing braze material 26 to form silicon carbide. Thus, the carbon source may be relatively free (e.g., not chemically bound within a molecule such that the carbon is non-reactive with silicon metal), and may be present in a porous or relatively fine form to provide surface area for the reaction between carbon and silicon metal.

The amount of carbon source in carbon-containing filler 24 may be based at least in part an amount of carbon used to react with silicon metal in molten silicon-containing braze material 26 to form silicon carbide. For example, a volume of joint 22 may be determined, and an amount of silicon carbide determined based on the volume of joint 22. The amount of carbon source in carbon-containing filler 24 may be selected based on the amount of silicon carbide determined to be in joint 22.

The amount of carbon-containing filler 24 may be selected based on the amount of carbon source. Further, the amount of carbon-containing filler 24 and the physical distribution of carbon-containing filler 24 may be selected based on the geometry of joint 22, e.g., to facilitate flow of molten silicon-containing braze material 26 to an internal volume of joint 22 (e.g., the volume of joint 22 opposite from silicon injection port 28). For example, if joint 22 defines a relatively long distance or tortuous path from the surface adjacent to silicon injection port 28 to the opposite surface of joint 22, carbon-containing filler 24 may include a higher porosity or may include less material than if joint 22 defines a relatively short distance or relatively straight path from the surface adjacent to silicon injection port 28 to the opposite surface of joint 22.

In some examples, carbon-containing filler 24 may include an optional reinforcement phase. The reinforcement phase may provide structural reinforcement contributing to mechanical properties of joint 22. In some examples, the optional reinforcement phase may include a similar material to the reinforcement in first ceramic or CMC part 14, second ceramic or CMC part 16, or both (if first ceramic or CMC part 14, second ceramic or CMC part 16, or both includes a reinforcement). For example, carbon-containing filler 24 may include a reinforcement phase including silicon carbide. The reinforcement phase in carbon-containing filler 24 may include, for example, particulates, chopped fibers, woven fibers, unidirectional fibers, or the like. The reinforcement phase may remain in joint 22 during and after reaction of silicon metal in silicon-containing braze material 26 and carbon in carbon-containing filler 24, forming a reinforcement phase in the matrix of silicon carbide formed by reaction of silicon metal in silicon-containing braze material 26 and carbon in carbon-containing filler 24.

System 12 includes silicon injection port 28. Silicon injection port 28 is optionally connected to a hopper 32, which holds silicon-containing braze material 26 in solid form. For example, silicon-containing braze material 26 may be in a powder or particulate form in hopper 32. In some examples, hopper 32 may be formed of graphite or silicon carbide. In some examples, hopper 32 may include a cooling system to control the temperature of silicon-containing braze material 26 so that silicon-containing braze material 26 remains in solid (e.g., powder) form in hopper 32.

Silicon-containing braze material 26 may include silicon metal or a silicon alloy. In some examples, the silicon alloy may include silicon metal alloyed with transition metals, transition metal carbides, transition metal borides, transition metal suicides, or mixtures thereof. For example, the alloying element may include at least one of titanium, boron, carbon, or the like. The alloying element may modify the melting temperature of silicon, modify the viscosity or wetting characteristics of the melted alloy compared to molten silicon, or the like. The silicon metal, the silicon alloy, or the silicon metal and the alloying element may be present in silicon-containing braze material 26 as a particulate.

Silicon injection port 28 is a structure that defines a passage from hopper 32 to adjacent to joint 22. For example, silicon injection port 28 may be an elongate structure defining a central passage through which silicon-containing braze material 26 passes, In some examples, silicon injection port 28 is a hollow cylinder with open ends.

In sonic examples, silicon injection port 28 is formed of a refractory material. For example, silicon injection port 28 may include silicon carbide. The silicon carbide may be silicon-rich, may include a protective coating on at least the inner surface to reduce or substantially eliminate reaction between silicon-containing braze material 26 and silicon injection port 28, or both.

Silicon injection port heat source 30 may be positioned adjacent to silicon injection port 28. Silicon injection port heat source 30 may be configured to heat silicon-containing braze material 26 in silicon injection port 28 directly, indirectly, or both, For example, silicon injection port heat source 30 may be an a resistive heat source that conducts heat to silicon injection port 28 to heat silicon injection port 28, and, indirectly, silicon-containing braze material 26. As another example, silicon injection port heat source 30 may be a coil about silicon injection port 28 and may inductively heat silicon-containing braze material 26.

Regardless of how silicon injection port heat source 30 heats silicon-containing braze material 26, silicon injection port heat source 30 may heat silicon-containing braze material 26 to a temperature above the melting point of silicon-containing braze material 26. For example, elemental silicon metal may melt at a temperature of about 1,414° C. Some silicon alloys may melt at lower temperatures than this. In some examples, silicon injection port heat source 30 may heat silicon-containing braze material 26 to a temperature between about 1,327° C. and about 1,427° C. Thus, silicon-containing braze material 26 exiting the end of silicon injection port 28 may be molten and flowable.

Optionally, system 12 also includes at least one heat source 36 configured and positioned to preheat at least one of the first ceramic or CMC part 14 or the second ceramic or CMC part 16. In some examples, without preheating at least one of the first ceramic or CMC part 14 or the second ceramic or CMC part 16, the at least one of the first ceramic or CMC part 14 or the second ceramic or CMC part 16 may be susceptible to cracking due to rapid heating of portions of at least one of the first ceramic or CMC part 14 or the second ceramic or CMC part 16 adjacent to joint 22 during introduction of molten silicon-containing braze material 26. In some examples, system 12 may omit at least one heat source 36.

In the example illustrated in FIG. 1, first heat source 36a is positioned adjacent to a first surface 40a of first ceramic or CMC part 14 and second heat source 36b is positioned adjacent to second surface 40b of first ceramic or CMC part 14. Similarly, third heat source 36c is positioned adjacent to first surface 42a of second ceramic or CMC part 16 and fourth heat source 36d is positioned adjacent to second surface 42h of second ceramic or CMC part 16. In other examples, system 12 may include more or fewer heat sources 36, e.g., only one heat source adjacent to each of first ceramic or CMC part 14 and second ceramic or CIVIC part 16. Each of heat sources 36 may be an inductive, conductive, or radiative heat source. Further, each of heat sources 36 may be the same, or at least one of heat sources 36 may be different than others of heat sources 36.

In some examples, heat sources 36 may heat first ceramic or CMC part 14, the second ceramic or CMC part, or both to a temperature of between about 900° C. and about 1,000° C. prior to or during introduction of molten silicon-containing braze material 26 to joint 22.

In some examples, system 12 may optionally include a getter 34. Getter 34 may be positioned adjacent to joint 22 on the side of first ceramic or CMC part 14 and second ceramic or CMC part 16 opposite to silicon injection port 28 (e.g., adjacent to second surfaces 40b and 42b). Getter 34 may getter e.g., absorb) excess silicon-containing braze material 26 that flows to the side of joint 22 adjacent to getter 34. In some examples, getter 34 may include graphite and may be porous.

In some examples, system 12 optionally includes a thermal masking material 38a and 38b (collectively, “thermal masking material 38”). Thermal masking material 38 may be positioned to reduce radiative heating of at least one of first ceramic or CMC part 14, second ceramic or CMC part 16, or joint 22 from silicon injection port 28 and the silicon injection port heat source 30. For example, as shown in FIG, 1, thermal masking material 38 may be positioned on first surfaces 40a and 40b of first ceramic or CMC part 14 and second ceramic or CMC part 16. In some examples, thermal masking material 38 partially overlap carbon-containing filler 24, shielding carbon-containing filler 24 from at least some heat generated by silicon injection port 28 and silicon injection port heat source 30. Thermal masking material 38 may include a thermally reflective material, such as a boron-nitride spray.

As shown in FIG. 1, to join first ceramic or CMC part 14 and second ceramic or CMC part 16, carbon-containing filler 24 may be positioned between joint surfaces 28 and 30. Optionally, getter 34 may be positioned adjacent to joint 22 and second surfaces 40b and 42b. Also optionally, first ceramic or CMC part 14 and second ceramic or CMC part 16 may be preheated using at least one heat source 36. Molten silicon-containing braze material 26 then may be introduced to joint 22 through silicon introduction port 28.

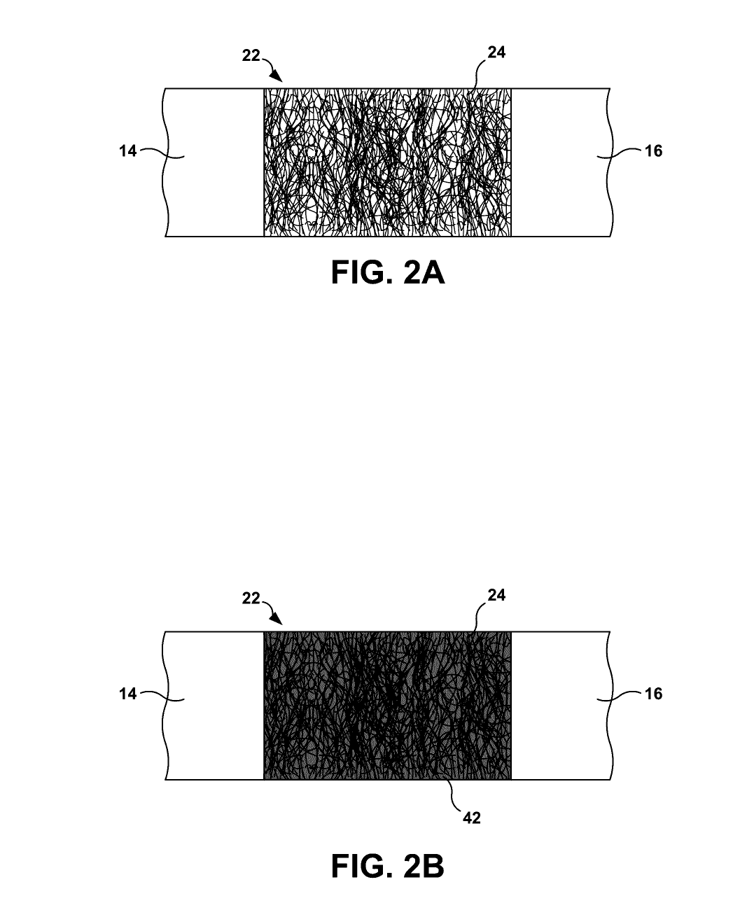

FIGS. 2A and 2B are conceptual diagrams illustrating an example joint 22 between a first ceramic or CMC part 14 and a second ceramic or CMC 16. As shown in FIG. 2A, before introduction of molten silicon-containing braze material 26 to joint 22, carbon-containing filler 24 is positioned in joint 22. As shown in FIG. 2A, carbon-containing filler 24 may be a porous material, defining pores between the carbon source and, if present, the reinforcement phase.

After introduction of molten silicon-containing braze material 26 to joint 22, silicon metal from silicon-containing braze material 26 reacts with carbon from carbon-containing filler 24 to form silicon carbide. The reaction between silicon metal and carbon may continue as molten silicon-containing braze material 26 propagates through joint 22. As the silicon metal and carbon react to form silicon carbide, the silicon carbide may solidify and form a matrix phase 42, as shown in FIG. 2B.

The reaction between silicon metal and carbon is exothermic. Thus, the reaction may provide heat to maintain molten silicon-containing braze material 26 in a molten state within joint 22. This may allow molten silicon-containing braze material 26 to propagate through joint 22, e.g., from adjacent to first surfaces 40a and 42a to second surfaces 40b and 42b. in some examples, because the reaction between silicon metal and carbon produces heat, no external heat source directly heats joint 22 during the reaction of the molten silicon-containing braze material 26 with the carbon-containing filler 24.

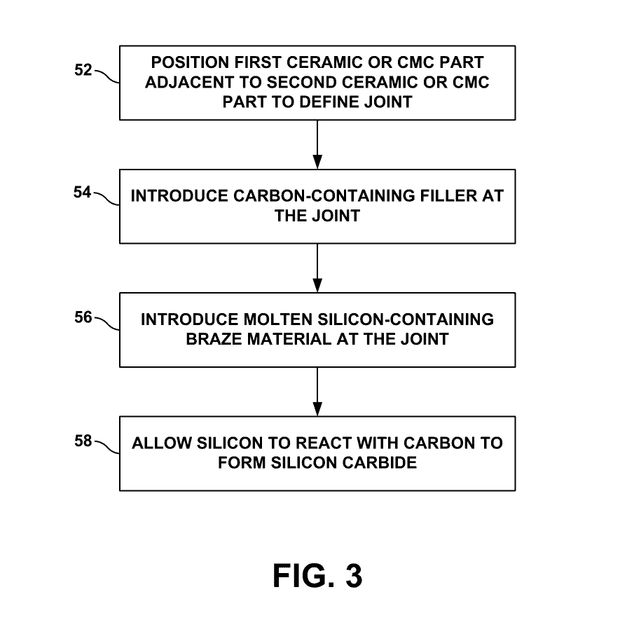

FIG. 3 is a flow diagram illustrating an example technique for joining a first ceramic or CMC part 14 and a second ceramic or CMC part 16 using a silicon-containing braze material 26 and a carbon-containing filler 24. The technique of FIG. 3 will be described with reference to the assembly 10 and system 12 of FIG. 1 for ease of description, although the technique may be performed using a different assembly or system in other examples.

The technique of FIG. 3 includes positioning first ceramic or CMC part 14 and second ceramic or CMC part 16 adjacent to each other to define joint 22 between adjacent portions of the first ceramic or CMC part 14 and the second ceramic or CMC part 16 (52). For example, as shown in FIG. 1, first ceramic or CMC part 14 and the second ceramic or CMC part 16 may be positioned so that joint surfaces 18 and 20 are near each other.

The technique of FIG. 3 also may include introducing carbon-containing filler 24 at the joint 22 (54). As described above, carbon-containing filler 24 may include a carbon source, and, in some examples, may include a reinforcement phase.

The technique of FIG. 3 additionally may include introducing molten silicon-containing braze material 26 to joint 22 (56). Molten silicon-containing braze material 26 may be introduced to joint 22 through silicon introduction port 28.

The technique of FIG. 3 further may include allowing silicon metal from silicon-containing braze material 26 to react with carbon from carbon-containing filler 24 to form silicon carbide (58). The reaction between silicon metal and carbon may continue as molten silicon-containing braze material 26 propagates through joint 22. As the silicon metal and carbon react to form silicon carbide, the silicon carbide may solidify and form a matrix phase 42. The reaction between silicon metal and carbon is exothermic. Thus, the reaction may provide heat to maintain molten silicon-containing braze material 26 in a molten state within joint 22. This may allow molten silicon-containing braze material 26 to propagate through joint 22, e.g., from adjacent to first surfaces 40a and 42a to second surfaces 40b and 42b. In some examples, because the reaction between silicon metal and carbon produces heat, no external heat source directly heats joint 22 during the reaction of the molten silicon-containing braze material 26 with the carbon-containing filler 24.

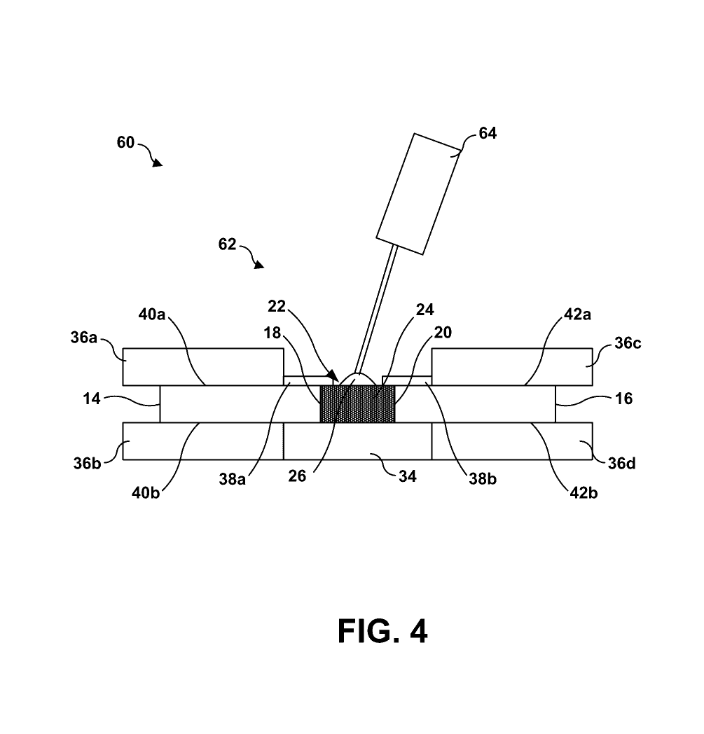

Although the preceding examples have been described with respect to a system 12 that includes a silicon injection port 28 that is heated to melt a silicon-containing braze material 26, in other examples, a different heat source may be used to heat silicon-containing braze material 26. For example, FIG. 4 is a conceptual and schematic diagram illustrating another example assembly 60 for joining a first ceramic or CMC part 14 and a second ceramic or CMC part 16 using a silicon-containing braze material 26 and a carbon-containing filler 24. Assembly 60, of which system 62 is a part, may be similar to or substantially the same as assembly 10 illustrated in FIG. 1, aside from the differences described herein.

Unlike system 12, system 62 includes a tungsten inert gas (TIG) welding heat source 64. TIG welding heat source 64 generates energy 66 used to melt silicon-containing braze material 26, which may be on the surface of carbon-containing filler 24 in solid (e.g., powder) form. As TIG welding heat source 64 melts silicon-containing braze material 26, molten silicon-containing braze material 26 infiltrates carbon-containing filler 24, and silicon metal in silicon-containing braze material 26 reacts with carbon in carbon-containing filler 24 to form solid silicon carbide. As described above, as this reaction is exothermic, heat from the reaction may help maintain silicon-containing braze material 26 in a molten state within joint location 22, allowing molten silicon metal to flow to substantially all areas of joint location 22, react with carbon, and form the braze joint at joint 22. As TIG welding is a localized heating technique, the heating may be localized to silicon-containing braze material 26 on the surface of carbon-containing filler 24, and no external heat source directly heats joint 22 during the reaction of the molten silicon-containing braze material 26 with the carbon-containing filler 24.

Various examples have been described. These and other examples are within the scope of the following claims.

What is claimed is:

1. A method comprising:
positioning a first ceramic or ceramic matrix composite (CMC) part and a second ceramic or CMC part adjacent to each other to define a joint between adjacent portions of the first ceramic or CMC part and the second ceramic or CMC part;
introducing a carbon-containing filler at the joint;
introducing molten silicon-containing braze material at the joint; and
allowing silicon metal from the molten silicon-containing braze material to react with carbon from the carbon-containing filler to form silicon carbide and join the first ceramic or CMC part and the second ceramic or CMC part at the joint, wherein no external heat source directly heats the joint during the reaction of the molten silicon-containing braze material with the carbon-containing filler.

2. The method of claim 1, further comprising:
preheating at least one of the first ceramic or CMC part or the second ceramic or CMC part to a temperature between about 900° C. and about 1,000° C. prior to introducing molten silicon-containing braze material at the joint.

3. The method of claim 1, wherein:
introducing molten silicon-containing braze material at the joint comprises introducing molten silicon-containing braze material through a silicon injection port to the joint; and
the silicon injection port is heated to a temperature between about 1327° C. and about 1427° C.

4. The method of claim 3, further comprising thermally masking at least one of the first ceramic or CMC part, the second ceramic or CMC part, or the joint to reduce radiative heating of the at least one of the first ceramic or CMC part, the second ceramic or CMC part, or the joint from the silicon injection port and the silicon injection port heat source.

5. The method of claim 1, wherein introducing molten silicon-containing braze material at the joint comprises introducing melting silicon-containing braze material using a tungsten inert gas (TIG) welding heat source and allowing the molten silicon-containing braze material to flow into the joint.

6. The method of claim 1, wherein the carbon-containing filler comprises at least one of:
a carbon yielding organic binder system;
a powder comprising graphite flakes;
a powder comprising carbon particles; or
carbon fibers.

7. The method of claim 1, wherein the carbon-containing filler further comprises a reinforcement phase, and wherein the reinforcement phase comprises at least one of:
silicon carbide particles;
chopped silicon carbide fibers;
unidirectional silicon carbide fibers; or
woven silicon fibers.

8. The method of claim 1, further comprising:
positioning a getter adjacent to the joint on an opposite side of the joint from wherein the silicon-containing braze material is introduced, and wherein the getter comprises graphite and is porous.

9. The method of claim 1, wherein the reaction between the silicon metal and the carbon is exothermic and generates heat that heats the molten silicon-containing braze material.

10. An assembly comprising:
a first ceramic or ceramic matrix composite (CMC) part;
a second ceramic or CMC part adjacent to the first ceramic or CMC part, wherein the first and second ceramic or CMC parts define a joint between adjacent portions of the first ceramic or CMC part and the second ceramic or CMC part;
a silicon injection port comprising an exit aperture positioned adjacent to the joint;
a silicon injection port heat source positioned to heat at least one of the silicon injection port or a silicon-containing braze material disposed in the silicon injection port; and
a carbon-containing filler at the joint, wherein molten silicon-containing braze material is introduced to the joint through the silicon injection port, wherein silicon metal from the molten silicon-containing braze material reacts with carbon from the carbon-containing filler to form silicon carbide and join the first ceramic or CMC part and the second ceramic or CMC part at the joint, and wherein no external heat source directly heats the joint during the reaction of the molten silicon-containing braze material with the carbon-containing filler.

11. The assembly of claim 10, further comprising:
at least one heat source configured and positioned to preheat at least one of the first ceramic or CMC part or the second ceramic or CMC part to a temperature between about 900° C. and about 1,000° C. prior to the molten silicon-containing braze material being introduced to the joint.

12. The assembly of claim 10, wherein the silicon injection port heat source is configured to heat the silicon-containing braze material disposed within the silicon injection port to a temperature between about 1327° C. and about 1427° C.

13. The assembly of claim 10, further comprising a thermal masking material positioned to reduce radiative heating of at least one of the first ceramic or CMC part, the second ceramic or CMC part, or the joint from the silicon injection port and the silicon injection port heat source.

14. The assembly of claim 10, wherein the carbon-containing, filler comprises at least one of:
a carbon yielding organic binder system;
a powder comprising graphite flakes;
a powder comprising carbon particles; or
carbon fibers.

15. The assembly of claim 10, wherein the carbon-containing filler further comprises a reinforcement phase, and wherein the reinforcement phase comprises at least one of:
silicon carbide particles;
chopped silicon carbide fibers;
unidirectional silicon carbide fibers; or
woven silicon fibers.

16. The assembly of claim 10, further comprising:
a getter adjacent to the joint on an opposite side of the joint from the silicon injection port, wherein the getter comprises graphite and is porous.

17. A system comprising:
a silicon injection port comprising an exit aperture positioned adjacent to a joint, wherein the joint is defined between respective surfaces of a first ceramic or ceramic matrix composite (CIVIC) part and a second ceramic or CMC part;
a silicon injection port heat source positioned to heat at least one of the silicon injection port or a silicon-containing braze material disposed in the silicon injection port to result in the silicon-containing braze material being a molten silicon-containing braze material; and
at least one heat source configured and positioned to preheat at least one of the first ceramic or CMC part or the second ceramic or CIVIC part to a temperature between about 900° C. and about 1,000° C. prior to the molten silicon-containing braze material being introduced to the joint, wherein a carbon-containing filler is positioned at the joint, wherein molten silicon-containing braze material is introduced to the joint through the silicon injection port, wherein silicon metal from the molten silicon-containing braze material reacts with carbon from the carbon-containing filler to form silicon carbide and join the first ceramic or CIVIC part and the second ceramic or CMC part at the joint, and wherein no external heat source directly heats the joint during the reaction of the molten silicon-containing braze material with the carbon-containing filler.

18. The system of claim 17, wherein silicon injection port comprises at least one of silicon carbide or silicon-rich silicon carbide and a protective inner coating.

19. The system of claim 17, further comprising a thermal masking material positioned to reduce radiative heating of at least one of the first ceramic or CMC part, the second ceramic or CMC part, or the joint from the silicon injection port and the silicon injection port heat source.

20. The system of claim 17, further comprising:
a getter adjacent to the joint on an opposite side of the joint from the silicon injection port, wherein the getter comprises graphite and is porous.
